(19) United States
(12) Patent Application Publication
(10) Pub. No.: US 2005/0015307 A1
(43) Pub. Date: Jan. 20, 2005

(54) METHOD AND SYSTEM OF PROVIDING LOCATION SENSITIVE BUSINESS INFORMATION TO CUSTOMERS

(76) Inventors: Todd Garrett Simpson, Calgary (CA); Christopher Edward Lugg, Calgary (CA); Danny Dace Lowe, Calgary (CA); Garry Dewayne Bunkowsky, Calgary (CA); Michael Alexander Sharp, Calgary (CA)

Correspondence Address: BENNETT JONES;C/O MS ROSEANN CALDWELL, 4500 BANKERS HALL EAST, 855 - 2ND STREET, SW, CALGARY, AB, T2P 4K7, CA

(21) Appl. No.: 10/709,298

(22) Filed: Apr. 27, 2004

Related U.S. Application Data
(60) Provisional application No. 60/465,679, filed on Apr. 28, 2003.
(60) Provisional application No. 60/474,403, filed on Jun. 2, 2003.

(51) Int. Cl. G06F 17/60

(52) U.S. Cl. 705/26

(57) ABSTRACT

A multi-modal system and method for providing automated directory assistance that can be personalized, and provide current information and promotions from a variety of businesses customers in need of goods and services that can be location sensitive. The multi-modal system can contain a database where business information can be categorized using parameters such as location sensitivity to make dialogs between customers and the system more efficient and valuable. Search results can be presented to customers using algorithms that prioritize the results using weighting schemes based on factors comprising for example proximity, relevancy, location, availability of promotions, and accessibility, and that randomize the prioritized results. The system abstracts the interface to this contact point, allowing businesses and customers to use different types of communication devices, including voice, messaging, web, and wap. Electronic marketing systems such as embedded customer relationship management, e-coupons, e-notifications, and location based services can also be included.

### BACKGROUND OF INVENTION

The present invention relates to the field of interactive systems for providing automated directory assistance to customers in need of goods and/or services that can be location sensitive.

When looking for goods and services today, a variety of approaches can be used by a potential customer. These approaches include browsing bulky telephone directories such as the Yellow Pages, consulting friends and acquaintances, viewing advertisements on television, looking at flyers, consulting agencies such as the Better Business Bureau, or browsing the Internet and online chat-rooms. If the name of the desired retailer or business is known, a directory assistance service such as 411 can be used.

A primary method that is used by customers to find goods and services is the telephone. However, the telephony experience, often associated with the use of telephone directories such as the White or Yellow Pages, is an inefficient means of finding current information on retailers and businesses. Such systems often do not offer current and/or sufficient information, are not ubiquitous and often appear either too complex to use or too impersonal. Further, by their nature, they are alphabetical making it difficult to search by other criteria, such as location. As is apparent, many different sources and points of contact may be required to find current and relevant information on particular goods and services.

Customers must often resort to calling each retailer or business independently, to obtain information beyond what can be found in telephone directories, other printed materials, and on the Internet. Customers are often interested in obtaining information such as location and directions, features of current goods and services offered, currently available specials and coupons, reputation, competitors, referrals, operating hours, ability to make reservations, purchasing options, and the like.

The current need to resort to phoning retailers and/or businesses can be easily understood, given the ease with which offers made by radio, through newspapers, in flyers, on the Internet, etc., may become outdated or inconsistent. For businesses and retailers, the control and management of a coordinated, up-to-date marketing and sales effort is expensive and difficult to maintain. A wide variety of retailers and businesses have no effective and affordable means of promoting and marketing their goods and services to their marketplace in a real-time manner, and have no means of connecting to pre-determined and self-qualified consumers who are ready to buy. Moreover, most marketing approaches have no auditable feedback mechanisms to judge the usefulness of their approach. In the state of the art, there is no single point of contact for retailers and businesses to control and target marketing information, nor is there a single point of contact for customers that can supply all of this information.

In an attempt to enhance the value of telephone directories and, among other functions, their ease of use, Voice Portals using Interactive Voice Response (IVR) and Text to Speech (TTS) systems have been introduced and their use has been steadily growing. However, to date, the major use for this technology has been in automated call centers and help lines. Many limitations have been encountered with voice systems, ranging from static behavior to low voice recognition rates to non-compelling voice synthesis. Due to these limitations, these systems have generally only been successful for call centers handling standard inquiries or problem reports. When used for generic information, these systems are often deployed only to get a small number of data elements, and then this information is handed forward to a human agent. Such is often the case with automated telephone directory systems such as 411.

Recently, IVR and TTS systems have seen dramatic improvements. Therefore, there is the potential for a business or retailer to use an intelligent voice system to provide current information. However, currently, only very large businesses or retailers can afford to maintain their own voice portal, as the cost must be scaled across a large volume, and the maintenance can be expensive.

Another problem with currently available information sources occurs when customers wish to locate a retailer and/or business for certain goods and services in proximity to their current location or within a certain specified location. Currently, once the retailer or business of interest has been chosen, the customer must use a map, or call the retailer or business again to get directions. In certain cases, the retailer or business will be located a significant distance away from the customer's residence or current location. More searching by the customer would be required to locate a retailer and/or business within the desired location.

The advent of Location Based Systems (LBS) begins to address some of these issues. The LBS can automatically pinpoint a customer's current location, so that information in proximity to the customer's location can be searched and presented. To do so, many geomatic databases contain data indexed by their longitude and latitude. However, most of these databases correspond to geo-indexed telephone directories, which only contain location information, but not necessarily current information, competitive elements, or consistent and universal messages and promotions. Moreover, such geo-indexed databases do not personalize the information given to a customer, even if the customer consistently looks for the same information. Further, these systems cannot directly connect customers to retailers and businesses.

Another problem with currently available information sources is that they only provide uni-modal interfaces either through voice, the Internet, the wireless application protocol (wap) or print, etc. However, it may be desirable for a business or retailer to have a uniform view of all of these advertising mediums for consistency. Thus, a need exists for a multi-modal interface, whereby an appropriate mix of voice and data based upon the customer's device capabilities and the message being delivered can be provided.

Consequently, the need has arisen for a multi-modal system providing for a single point of contact that can connect customers to multiple retailers in an efficient and organized manner and provide current information in a timely, localized, and possibly personalized fashion.

### SUMMARY OF INVENTION

In accordance with a broad aspect of the present invention, there is provided a system for generating business information for a customer, the system comprising: a geo-indexed database including information on a plurality of businesses; a logic processing unit through which each business in the database is assigned to a business category and for associating criteria to each business category; and a customer interface to the logic processing unit for allowing a customer to enter a search request to locate a business within a selected business category, the logic processing unit determining the appropriate information to be gathered from the customer and generating a list of businesses based on the business category selected by the customer.

In accordance with another broad aspect of the present invention, there is provided a multi-modal system to provide contact between a business and a customer comprising a geo-indexed database including data about the business; a logic processing unit, providing access into said geo-indexed database; a business interface to the system, allowing a business to control the data; and a customer interface to the system allowing the customer to search the business data to locate a business of interest, wherein, based on a customer search, the logic processing unit generates and prioritizes a search result including a list of businesses prioritized on the basis of business location sensitivity and business score from weighing factors.

In one embodiment, the logic processing unit randomizes the prioritized search results. In one embodiment, the search results are prioritized using weighting factors selected from the group consisting of relevancy, accessibility or availability of promotions. In one embodiment, the weighting factors include ratings from previous customers. In one embodiment, the weighting factors include the businesses' status in a tiered rate structure system. In one embodiment, the database groups businesses into categories including a pre-set location sensitivity. In one embodiment, at least one of the business interface or the customer interface is voice and audio. In one embodiment, the multi-modal system comprises a seamless integration of prerecorded voice segments, audio clips, and TTS components. In one embodiment, at least one of the customer interface and the business interface is a data, web or wap interface. In one embodiment, the logic processing unit allows the customer to perform personalized or location sensitive searches. In one embodiment, the multi-modal system further comprises an auditing and feedback function. In one embodiment, the multi-modal system further comprises a function whereby electronic promotions are sent to the customer. In one embodiment, the geo-indexed database includes material available to specific groups of customers. In one embodiment, the multi-modal system further comprises a billing function. In one embodiment, the billing function includes a tiered rate structure for businesses. In one embodiment, the billing function includes a per search request fee for the customer. In one embodiment, the billing function includes a fee for the business for every instance of inclusion on a list of search results. In one embodiment, the customer is connected to the business. In one embodiment, the customer registers with the multi-modal system to provide feedback and to obtain promotions. In one embodiment, location and communication device information is obtained from the customer's communication device or from the customer.

In accordance with another broad aspect of the present invention, there is provided a method for generating business information for a customer, the method comprising: providing a geo-indexed database including information on a plurality of businesses and a logic processing unit through which each business in the database is assigned to a business category and for associating criteria to each business category; accepting a search request from the customer to determine a business category of interest to the customer; and operating the logic processing unit to obtain appropriate information from the customer based on the criteria associated with the business category of interest and searching the database to generate a list of businesses from the business category selected by the customer.

In accordance with another broad aspect of the present invention, there is provided a method for providing business information to a customer from a business comprising: receiving a search request in a data, voice, or messaging format from a customer from a communication device, the search request specifying business information of interest and a location of interest; converting the search request to a digital signal representation understandable by a computer system; in response to the search request, assigning a location specificity to the business information of interest and searching a geo-indexed database of business information for a particular data item relating to the business information of interest; with reference to the location specificity of the business of interest, prioritizing search results based on proximity to the location of interest; and generating a list of prioritized search results into the format used for the search request.

In one embodiment, the prioritized search results are randomized. In one embodiment, prioritizing the search results further includes scoring by applying weighting factors. In one embodiment, the weighting factors include ratings from previous customers. In one embodiment, the weighting factors include the businesses' status in a tiered rate structure system. In one embodiment, the search is personalized by the customer. In one embodiment, the method further comprises a registration step whereby a customer registers and obtains a login name and password. In one embodiment, a registered customer provides business ratings and requests promotional material. In one embodiment, the method further comprises a step of charging the customer a fee for each search request. In one embodiment, the method further comprises a step of charging businesses a fee for each instance of inclusion on a list of search results. In one embodiment, the method further comprises a step of obtaining location and communication device information from the customer or from the customer's communication device. In one embodiment, the method further comprises a step of directly connecting a customer with a business.

In accordance with another broad aspect of the present invention, there is provided a method of presenting results obtained from an automated directory assistance system comprising prioritizing the results using weighting factors comprising relevancy and location, and randomizing the prioritized results.

In one embodiment, the weighting factors include ratings from previous customers. In one embodiment, the weighting factors include the businesses' status in a tiered rate structure system.

### BRIEF DESCRIPTION OF DRAWINGS

FIG. 1 is a high level view of one embodiment of the multi-modal system of this invention.

FIG. 2 is a diagrammatic illustration showing an exemplary embodiment of the voice interface in the multi-modal system of this invention.

FIG. 3 is a diagrammatic illustration showing a sampling of the data elements available to a business or retailer to set up and control the information inputted into the multi-modal system of this invention.

FIG. 4 is a diagrammatic illustration showing an exemplary embodiment of a flow chart of a customer interaction with the multi-modal system of this invention.

### DETAILED DESCRIPTION

A system, as described herein, provides for a single point of contact that can connect customers to multiple retailers in an efficient and organized manner, and provide current information in a timely, localized, and possibly personalized fashion. Information can be presented to customers through the use of algorithms that prioritize the results using a variety of weighting factors comprising, for example, proximity, relevancy, location, availability of promotions, and accessibility, and that randomize the prioritized results. The system may provide businesses with the ability to personalize and update their marketing strategies and promotions in almost real time, and may also provide feedback on the type and frequency of customers using each of their goods and services offers.

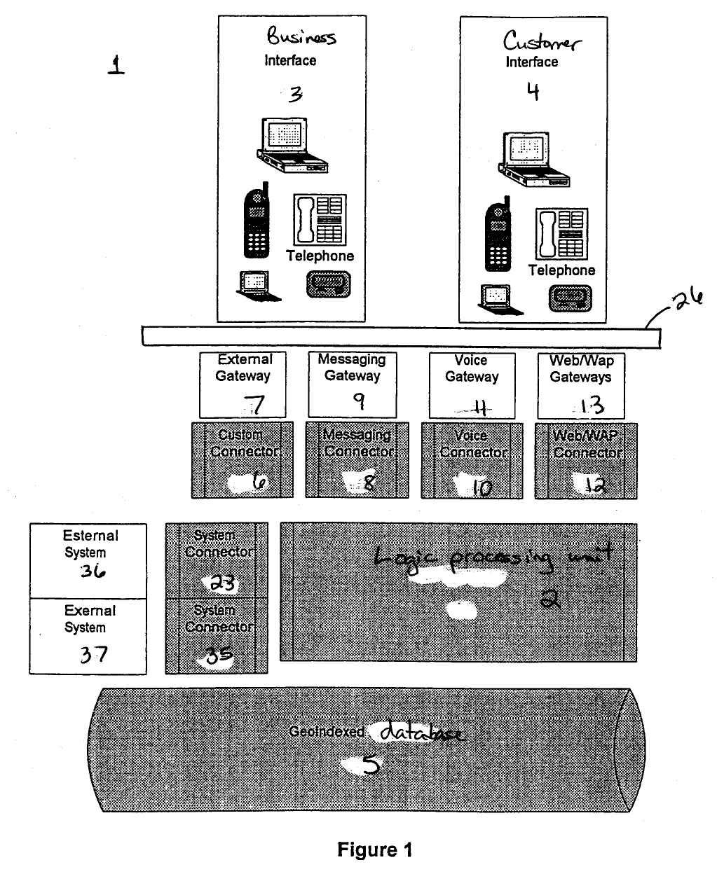

FIG. 1 shows a possible embodiment of a multi-modal system 1 of the present invention, which comprises at least a logic processing unit 2, a business interface 3, a customer interface 4, and a geo-indexed database 5.

Multi-modal system 1 can create a single point of contact between various businesses and customers, where businesses and customers can be brought together in a user-friendly fashion to obtain current and personalized information. In multi-modal system 1, different formats of communication can be used together to facilitate and encourage use. In one embodiment, multi-modal system 1 can interact with any permanently connected or periodically connected device. As examples, which are not meant to be limiting, devices such as landline telephones, cellular phones, smart phones, personal data assistants (PDAs), internet appliances, personal computers, Voice-over-IP devices, wireless application protocol (wap) based devices and the like can be interfaced with multi-modal system 1. Of course, one skilled in the art will understand that many different communication devices are available and continue to evolve rapidly, and although the details of different communication devices may vary greatly, each can be easily interfaced with multi-modal system 1.

Interfacing multi-modal system 1 with various communication devices can be accomplished through the use of a number of connectors and gateways. As is apparent, the types of connectors and gateways that will be used will vary with the type of communication device. In one embodiment, as shown, a custom connector 6 and an external gateway 7 can be used for a proprietary paging system, internet protocol telephone, or any other networked device. A messaging connector 8 and a messaging gateway 9 can be used for existing and evolving messaging interfaces such as Short Messaging Service (SMS), Extended Short Messaging Service (EMS), Multimedia Messaging Service (MMS), Instant Messaging, and the future evolution of these. A voice connector 10 and a voice gateway 11 can be used for voice interfaces, supporting both landline and cellular access as well as Voice-over-IP. A web/wap connector 12 and a web/wap gateway 13 can be used for Internet content.

Custom connector 6, messaging connector 8, voice connector 10, web/wap connector 12, external gateway 7, messaging gateway 9, voice gateway 11 and web/wap gateway 13 can comprise a number of different components. These components can include, but are not limited to, an interaction protocol, such as VoiceXML, a text to speech engine, a voice recognition system, and the like. Some of these components can be handled by telecommunication companies, although some components may be supported and hosted by custom voice companies.

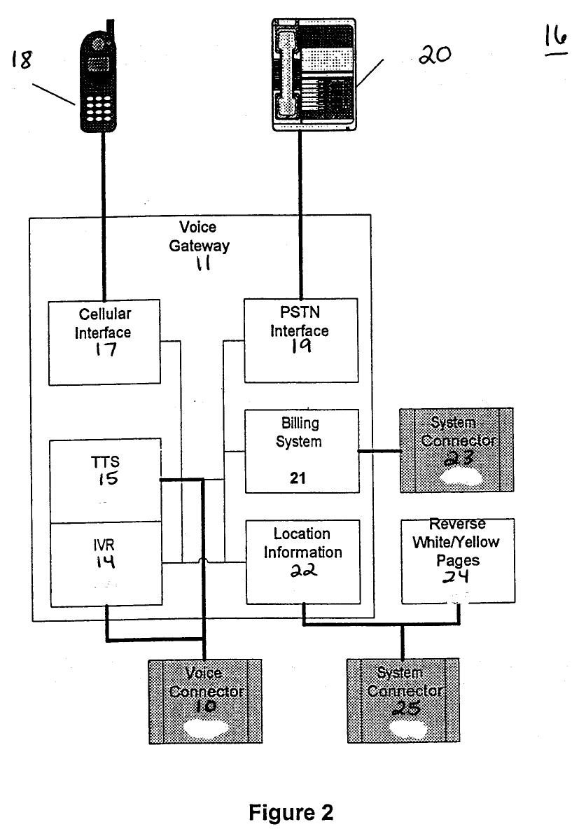

A possible embodiment of a voice interface 16 including voice connector 10 and voice gateway 11 is illustrated in FIG. 2. In this embodiment, voice connector 10 can connect primarily with an Interactive Voice Recognition (IVR) system 14, and a Text to Speech (TTS) system 15. IVR system 14 can convert a voice excerpt into a written, text segment of a specific human language, such as English, and can pass its interpretation of the voice excerpt back to voice connector 10. As is apparent, any human language could be used by IVR system 14. TTS system 15 can take a written text segment of a human language and convert it to an audio excerpt. The primary interface between voice connector 10 and IVR system 14 and TTS system 15 can be VoiceXML, although other formats are also acceptable.

Voice interface 16 can offer a primary access method. Using this configuration, incoming calls to multi-modal system 1 can be routed to voice gateway 11 where any audio input can be converted to and from its interpreted format, using a variety of different mechanisms such as VoiceXML. IVR system 14 can be configured to recognize particular grammars to enhance the recognition rate within each step of a dialog between multi-modal system 1 and a customer. Although dialogs can be structured to allow for free form input, directed dialogs can be used should multi-modal system 1 require it. For example, customers that have heavy accents can be led to a directed dialog where simple voice commands such as numbers are recognized instead of complex terms such as retailer names. In another embodiment, voice interface 16 can support DTMF tone based interaction, where the customer can use a keypad on their communication device to facilitate communication with multi-modal system 1. As an example, the customer may be prompted to “Say or touch 1 for response X”.

IVR system 14 and TTS system 15 can connect to both a cellular interface 17, allowing for mobile access 18, and to a PSTN interface 19, allowing for landline usage 20. Voice-over-IP access can also be possible through voice connector 10. These systems can also be interconnected to two other components, a billing system 21, and a location based system (LBS) 22.

As will be described below, billing system 21 can be integrated with logic processing unit 2 using an external connector, such as system connector 23. Billing system 21 can be used to implement several different billing options such as pay-for-performance and may be used to impose fees on both customers and businesses, if desired. For example, which is not meant to be limiting, a fee for each search request could be imposed on customers, whereas a fee for each instance of inclusion on a list of search results could be imposed on businesses. It may also be desirable to include components of billing system 21 within multi-modal system 1 if features such as bill-to-phone or third-party billing are not required. In this manner, it is possible to maintain a generic billing interface.

Location information can help tailor searches in multi-modal system 1 and results that are reported to a customer. To obtain location information, LBS 22 may get information from the cellular system based on cellular phone identification, which corresponds to the cell site to which the phone is currently connected, a global positioning system (GPS), or an assisted GPS (AGPS) that uses a combination of cell site and GPS to establish location. If desired, many of these components can be standardized as telecommunication companies adopt and support e911 services. LBS information from the landline can come from a telecommunication company, or from third party reverse Yellow/White page directories 24.

In one embodiment, LBS information may be provided by a customer when the customer registers with multi-modal system 1 by voice, text, or handwritten input. Location information may take the form of an address, an area, a postal code, or any other information that can identify a region of interest. In the event that LBS information is not available, such as when a customer specifically blocks it, customer interface 4 can be configured to query location information from the customer if desired. In one embodiment, the integration of all these sources is done by another external connector, such as system connector 25.

As is apparent, external gateway 7, messaging gateway 9, voice gateway 11 and web/wap gateway 13 can be connected to telecommunication networks 26 to facilitate interfacing between the customer's communication device and multi-modal system 1. As examples, which are not meant to be limiting, telecommunication networks 26 can be publicly accessible telecommunication company switching and data equipment, a wireless LAN hotspot provider, or any other entity providing telephony services, including Voice-over-IP providers.

Businesses can also easily connect, in much the same manner as for customers, with multi-modal system 1. Business interface 3 can be used by businesses to input information about their marketing initiatives and/or goods and services into multi-modal system 1 using a wide variety of communication devices. This type of configuration can allow, if desired, for near real-time feed-back between service updates and client accesses, as well as to ensure the consistency of the data across the various interfaces of multi-modal system 1. As is apparent, access to business interface 3 can be limited, if desired, to businesses that have subscribed to multi-modal system 1 and pay membership fees.

As used herein, the term “real-time” feedback or access is meant to include a small delay due to computer processing of information submitted by a business and accessed by a customer. By near “real time”, the notion of auditing updates is introduced. In one embodiment, when a business submits new information, the process may include a review of that information by a software program or a human operator. This process can help to ensure that negative or potentially damaging information is excluded from entry into multi-modal system 1. As is apparent, the delay in the auditing process may be longest when a human operator is involved, and can then be dependent on the volume of updates.

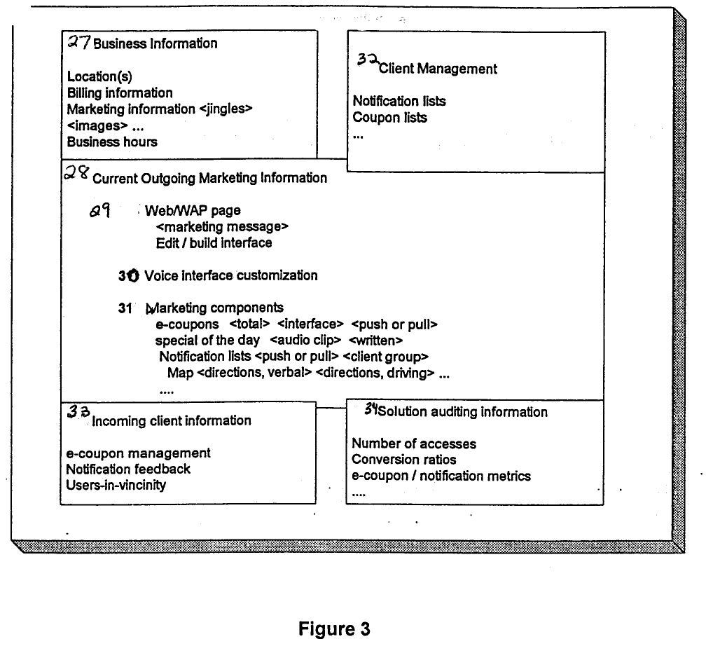

As illustrated in one embodiment shown in FIG. 3, a business may select from several different interactive components to enter information into multi-modal system 1. As is apparent, components could easily be removed or added depending on the intended application. In component 27, the mainly static information about a business can be entered. This type of information can include much of the data that would be found in the yellow pages such as address, phone numbers, logo, images, and the like, as well as billing information, business hours, business category type, etc. In one embodiment, business category type can be selected by a business itself. In another embodiment, business category selection can be done by multi-modal system 1 or through the intervention of a human agent.

Component 27 may also include audio excerpts, such as a corporate jingle or introduction that is part of the business' marketing strategy. As is apparent, such multi-media information can be used with interfaces supporting it. For example, audio can be used in voice interfaces, while video can be used in web, and eventually, wireless data interfaces. Because multi-modal system 1 provides a single point of contact for a business to market itself, the other components illustrated in FIG. 3 can function to provide a business with real-time marketing and auditing capabilities.

In one embodiment, component 28 can provide a platform to businesses for presenting current marketing messages. Subcomponent 29 can represent a web/wap page maintenance and update system, which can provide a business with the ability to maintain, in real time, the format and content of personalized web/wap pages. Further, this subcomponent can be configured to use the static information from component 27 so that long-term information changes such as address or telephone number, for example, can be automatically updated in all web/wap pages of the business. Subcomponent 30 can be configured to be the equivalent of subcomponent 29, with the exception that it is to be interfaced with voice-based communication devices, thereby allowing a business to change its voice message delivery. A business' voice message delivery can include, for example, which is not intended to be limiting, services offered by voice such as directions, connection through to the business, direct to voice-mail, specials, coupons, notifications, joke-of-the-day, and the like, as well as the dialog and grammar surrounding the voice messages.

Subcomponent 31 can comprise some of the marketing components that can be used by a number of communication devices. In one embodiment, subcomponent 31 can be used to update items like daily specials and to give customers directions, either through voice, with a map, or through a combination of both. Subcomponent 31 can also contain electronic coupons, which can be sent to a customer's communication device using a number of methods such as electronic text messaging, voice messaging, etc., for later retrieval. For businesses, electronic coupons can have a high degree of control, including the ability to target specific groups of people, to restrict the total number of coupons issued, to limit the validity of the coupons to certain times, etc.

Electronic coupons, or e-coupons, can be an important marketing tool managed by multi-modal system 1. An e-coupon can be any promotional item that can be delivered to a customer and then used with a given retailer. Examples would be a keyword given through a voice interface (for example, “Say Twin Turkey to the check-out person to receive 30% off your second Turkey”), through a messaging interface, where a relatively small amount of data is sent to the receiving device, or through a data interface. In the case of data interfaces, an e-coupon may be a numbered, controlled item such as a barcode or an alphanumeric identifier. E-coupons may have tightly controlled time spans, or only target consumers within given geographies. Such e-coupons may be auditable and traceable. E-coupons can be flexibly managed within multi-modal system 1, allowing businesses to configure the delivery and auditing of the promotion. Registered users can be audited based upon their permission settings, while anonymous and aggregate auditing can be done across all usage. E-coupons can support the multi-modal interfaces, where, for example, a voice command can trigger the delivery of a data based e-coupon.

In one embodiment, component 32 can house a generic Customer Relationship Management (CRM) component. Component 32 can provide a business with the ability to manage in near real time lists of customers who have registered with multi-modal system 1 and notify these customers of promotions or other goods and services through various messaging mechanisms such as electronic coupons, and the like.

In one embodiment, component 32 can function with component 33, which can provide a close to real-time view of customers who have registered (or allowed access to themselves) for a specific service. Component 33 can alert a business when a customer carries out a specific action, when they are in the vicinity of the business, etc and can provide feedback on a business's marketing strategy. In one embodiment, this component can be used to support loyalty programs, or promotions based on proximity or time, and the like.

In one embodiment, component 34 can provide a business with the ability to audit or monitor how multi-modal system 1 is serving their needs. This component may provide the number of web hits, the number of voice calls, the number of connections from voice calls, the number of electronic coupons converted, the number of notifications acted upon, and the like.

In one embodiment, business interface 3 can also allow member businesses to register and pay for a service, whereby registered businesses can be retrieved by popular name by customers instead of by business category. Searching by popular name can allow a customer to specifically request a business by name, rather than having to initiate a longer dialog with multi-modal system 1 to establish the business category of interest. As is apparent, registration for such a service may be included in any component or subcomponent described above, or may be part of a separate component, if desired.

The information submitted through the gateway and connector layers of multi-modal system 1 may be added to or used to query geo-indexed database 5 by logic processing unit 2. In one embodiment, logic processing unit 2 is a software system coordinating data flow between businesses and customers. Logic processing unit 2 can manage the way in which information from businesses is updated to help maintain consistency. As is apparent, logic processing unit 2 can be scalable across multiple databases, across multiple servers, across connectors, across gateways, and the like. In one embodiment, logic processing unit 2 can also manage the auditing of usage and the filtering of actions and transactions occurring through multi-modal system 1 to provide feedback.

Logic processing unit 2 can be used to format search commands and to prioritize search results according to a prioritization and randomization algorithm based on a variety of weighting factors, for example. In one embodiment, the order in which search results are presented can be dependent first on business category, then location, and, if desired, other weighting factors that can be used to assign various businesses a score. Of course, the order of search results can be determined using these factors in a different sequence, if desired.

The weighting factors that can be used to assign scores to businesses can be quite varied and can include parameters such as location, accessibility, availability of coupons or other promotions, and the like. The use of various weighting factors can ensure that the most relevant businesses can be presented to a customer. In one embodiment, the use of such weighting factors can result in the presentation to a customer of both member and non-member businesses because both types of businesses are relevant to a customer's search. As is apparent, however, information presented to a customer on non-member businesses can, of course, be more limited and static than that presented for member businesses.

Another weighting factor that can be used comprises the businesses' status in a tiered rate structure system. In a tiered rate structure system, member businesses can pay higher fees to ensure higher prioritization in returns from searches. For example, a flower shop may have paid for top-tier status, implying that they are often recommended as the first flower shop to potential clients. When using a tiered rate structure, randomization of the search results can ensure that the same business is not always the first candidate returned from a search, but that businesses having the same or similar ratings have equal potential to be listed first, second, third, etc. within the tier for which they have paid. Other types of prioritization may include co-marketing or co-branding. Alternately or in addition, prioritization may include the presentation of a richer interface through enriched audio offerings, electronic coupons, and the like.

In one embodiment, consumer weighting can also be used. Consumer weighting can be based on previous usage of businesses by customers and can affect the manner in which those businesses are presented in multi-modal system 1 in the future. Feedback may be extrinsic, through direct feedback from the customer, or intrinsic based on usage patterns, call completion rates, and the like.

To aid fluidity in communication between the different components of multi-modal system 1, logic processing unit 2 can use a variety of interfaces such as system connectors 23 and 35 to communicate with external systems 36 and 37. External systems 36 and 37 can take on several different forms, which can include, for example, billing systems, telecommunication companies, geomatic information sources, rating services, various bureaus, online databases, etc. System connectors 23 and 35 can allow logic processing unit 2 to access any desirable information source and be accessible from a variety of different locations.

In one embodiment, logic processing unit 2 can act as a personalization engine, and communicate directly with telecommunication networks 26 to gather information about customers and businesses, and their communication device. Of course, one skilled in the art will understand that this type of information could also be gathered by other components of multi-modal system 1.

Information on a customer or business and their communication device can be used to personalize interactions, because an important aspect of multi-modal system 1 can be a customer's and business' experience in using it. Examples of information used to personalize interactions, which are non-inclusive, are device type, screen resolution and type, input modes (for example, keypad, keyboard, stylus, touch screen, and the like), privacy settings (for example, enabling or disabling of caller ID functionality), location information (for example, mappings from IP addresses to physical locations, reverse white pages, reverse yellow pages, GPS, AGPS, cellular phone site identification, location, and the like). All of this information can be used, when available, to provide a customer with a richer and more relevant experience.

Interactions with logic processing unit 2 can be mediated by standard protocols, such as Session Initiation Protocol (SIP) for Voice-over-IP, or protocols that are custom to the telecommunication company. In one embodiment, the gathering of data on a customer's communication device can allow for the delivery of information through multiple modes of messaging. A relevant example is the combination of voice and web/wap content. With the advent of short distance wireless protocols such as bluetooth, and the usage of wired headsets, customers are able to talk into their phone using the headset at the same time as viewing the screen. This allows voice interaction to be combined with data downloads/uploads from a phone to be managed by the customer in parallel. From a marketing standpoint, the list of businesses being browsed by a customer may be presented verbally while their logos, retail images, advertisements, or other marketing materials are shown on the screen. The customer may select a business, or a service from a business, using either voice commands or physical commands from their device. A multi-modal interface does not require a headset. The user may switch back and forth from having their device next to their ear, and then where they may view and interact with it.

In one embodiment, to further personalize a session, a customer may register with multi-modal system 1 to receive more targeted information. Registration is not mandatory, but is possible, and may be linked to enhanced services. During registration, a customer may choose to enter preferences, dislikes, personal characteristics, most often used services, modes of access affinity to marketing approaches, and the like. For example, through voice interface 16, a customer can log in using voice verification and authentication techniques, and can then access both a personalized list of services or the general list of retailers with all its relevant information. As is apparent, when a customer has been authenticated in a static location, current location information is no longer required. In another embodiment, a customer may also register with particular businesses, where they can become eligible to receive various promotions such as electronic coupons. Registered customers may also take part in evaluations and surveys to generate feedback data.

As is apparent, customer registration information can be stored in a variety of locations in multi-modal system 1, including in geo-indexed database 5. Geo-indexed database 5 can contain a wide variety of indexed data, which can comprise location information for each business, customer registration information, and the like. In one embodiment, geo-indexed database 5 can contain categorized business information, wherein each business can be assigned to a business category. In each business category, category-specific information can be included, such as, for example, whether location, accessibility, and the like, are important factors for a certain business category. If desired, this categorized information may influence the types of questions that can be posed during a dialog between multi-modal system 1 and a customer.

As is apparent, geo-indexed database 5 can include information on both member businesses that have paid membership fees as well as non-member businesses, if desired. In one embodiment, member businesses can enter a wide variety of data, whereas non-member businesses can be limited to more static data such as that which is usually contained in directories such as the Yellow Pages.

Data within geo-indexed database 5, in combination with logic processing unit 2, can allow for flexible application of location information. For example, many geo-indexed sources are based upon distance, either using a direct point-to-point calculation or a combination of point-to-point calculations based on roadways or paths. In one embodiment, multi-modal system 1 can comprise a distance function based on the type of service being accessed. For example, a nearby coffee shop does not have the same interpretation as a nearby oriental rug dealer; in the first case the user can justifiably expect a coffee shop within a few blocks, when in a highly populated area, or within a mile or two if in outlying areas. For example, even within a highly populated area, the rug dealer may be expected to be at a much greater distance (and there are probably fewer of them). As another example, a user will be more willing to travel further to a high end furniture store than to a low end store. This is an example of “relevant” data for a given business. Thus, it is important to encode a sense of a customer's expectations. In one embodiment, this may be done through the use of categorized business information, as described above.

Location data can allow for a variety of location dependent services beyond those already mentioned. The location information may also be used to service the customer, as opposed to leading a customer to a service. An example of this is when the business provides a taxi service. The customer's location can be used to better schedule a taxi, and potentially to find the customer automatically instead of through voice interaction. Similar services can be offered by other transportation retailers. The location can also be used to perfect a marketing message or promotion. If the location is a high-end neighborhood the message may be different than from a low-end neighborhood. Not only may a business' message be different in this case, the list of retailers may be categorized and presented differently based on such information. In this case, high end automobile dealerships may be presented before lower end automobile dealerships.

One aspect that may affect a customer experience can be the way in which information is retrieved by the system. The complexity of the problem can be seen with a few examples. The customer may want to book dinner at an Italian restaurant downtown: in this case the desired service type, or category has to be found, the desired location, and possibly the customer's current location so that driving directions can be relayed. The location data can be found to different resolutions. If the customer is calling from home, their current location may be ascertained through a reverse white pages lookup, or from previously stored data. However, if they have a privacy setting which blocks caller ID, or have specifically limited location information, they must be guided through a voice conversation in order to establish their current location. Similar situations arise with cellular telephone use. In order to define “downtown”, the system must have an understanding of a fuzzy boundary that may not be as defined as an area on a map. Further, it may be important to know the users means of travel: on foot, by car, on public transport, for example. Accessible Italian restaurants may be a different set of restaurants than just taking “downtown Italian” restaurants as a whole.

As a second example, the customers may want to deliver flowers to their grandmother. In this example, the location of the customer may be immaterial (unless they have a favorite flower shop close by), and they may simply want any flower shop with country wide delivery or a flower shop located close to their grandmother's location. Thus, the service type, or category, may drive the need for location information, or at least location sensitivity. However, if the interface does not allow the user to select a flower shop nearby, it may not be providing the acceptable utility.

Finally, businesses within a category may have preferred status based on a business relationship. For example, a global flower shop may have paid for top-tier status, implying that they are often recommended as the first flower shop to potential clients. There may be some number of top-tier businesses, and a means to present them in a fair manner, combined with them being within/without an accessible region for the user is a complicated task.

In general, a business may be ranked within the system based on a scale or “points”. As is apparent, the more “points” a business has, the higher they will be ranked. The points need not be one-dimensional values, but could be a multi-dimensional or calculated value based on the business proposition. For example, “points” can be calculated using the weighting factors described above, if desired, and can be determined by logic processing unit 2, as briefly described above. This type of ranking may be of greater importance in voice interface 16. Further, as a customer will typically expect a choice when looking for a service, a minimum or standard number of accessible businesses may be returned.

In one embodiment, “accessible” can also be a ranked value, with some businesses being more accessible than others for a customer. Accessibility can depend on a wide variety of factors such as the customer's current location, available mode of transportation, and the like. For example, a customer may communicate with multi-modal system 1 from a location that is near a walkway or pedestrian bridge. The customer may request a specific type of business from multi-modal system 1. The customer's current location can be used by the system to suggest a business that would be located a short walking distance away using the walkway or pedestrian bridge, but would require a significantly longer amount of time if the customer were using another means of transportation, such as one that could not use the walkway or bridge. As is apparent, a customer's location and available means of transportation can be factors in determining accessibility.

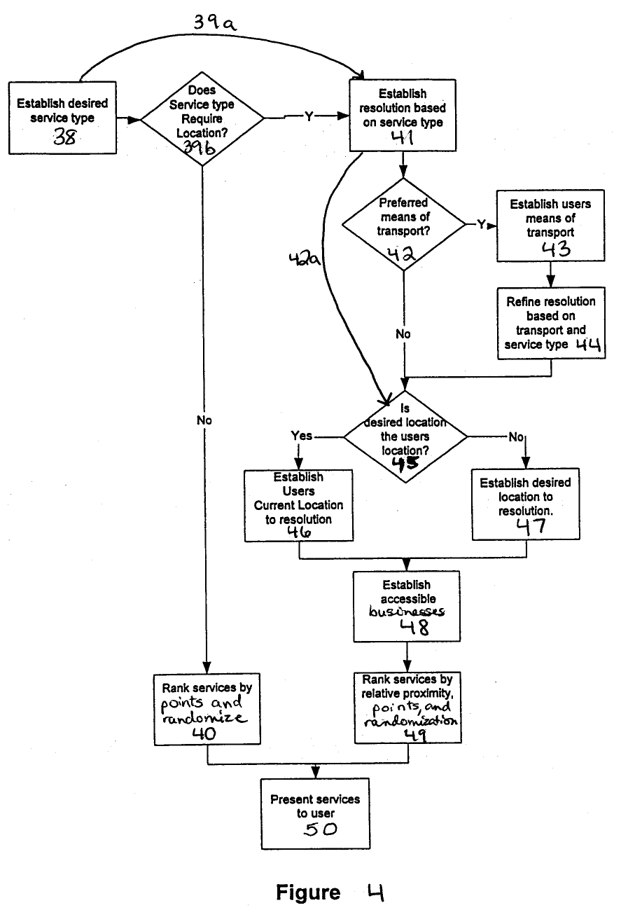

A flow diagram is provided in FIG. 4 showing a call handling procedure by a multi-modal system. In a call, a customer connects with the system in order to locate business data. The customer enters search criteria and the system generates a search result including a list of businesses meeting the search criteria. The search results are generated based on a geo-indexed database containing business data.

While the system can be based on various forms of communication, the illustrated procedure is based on voice interaction between the system and the customer. Thus, while the system contemplates voice reception, it could operate using computer data entry, telephone keypad entries, tones, etc. The illustrated procedure is for a predetermined area, such as a city. In one embodiment, a call handling procedure may include a query to determine the area of interest to the customer.

To facilitate call handling and customer satisfaction due to, for example, speed and relevancy of response, the illustrated system may categorize the business data and use logic based on the category of business of interest to the customer. Thus, during the call handling procedure of FIG. 4, a business category of goods and services is determined as a first step 38. The category can be determined by a dialog with the customer. The categories available for searching by the customer may be preset by the system. Categories may, for example, be similar to those available in a telephone directory, such as the Yellow Pages. While the system responds to a voice response of the category of interest, the system may include various options, such as synonym programs, “sounds like” options, etc., to guide the customer to an appropriate category. Since some customers may be interested in finding a business of a known name, the system may also recognize popular business names and interface such names with preset categories.

Based on the business category of goods and services selected in step 38, the system may be modeled to guide the customer through an appropriate call routine in order to finally generate and present a search result of suitable businesses to the customer, as set out in step 50.

In the illustrated embodiment, each business category is assigned a location-sensitivity. For example, business categories may range from those that are location sensitive to those that are not location sensitive. For example, as described hereinbefore some business categories may be more or less location sensitive due to the relative density or the number of businesses in that category, (i.e., coffee shops vs. automobile dealerships). As another example, other business categories may be more or less location sensitive due to the nature of the business (i.e. a business, such as a restaurant, requiring the attendance of a customer vs. a business, such as a plumber, that comes to the customer's location). Based on the category, therefore, the system then may generate various queries to obtain further information. For example, after determination of the category, the system will either begin directly 39a an assessment based on a set location sensitivity. Alternately, for a category which may or may not be location sensitive, such as a florist which can be local and location specific or non-location specific with a broad delivery area, the system can generate a query, step 39b, to determine if location is important to the user. In response to this query, the customer may indicate that location is not important, where they for example require any national supplier, and the system will provide results based on other factors, as shown in step 40, which is described further hereinbelow.

In the event that the customer determines location to be an important factor in step 39b, the system continues processing based on the business category selected by the customer.

Thus, either because the customer determined the category to be location specific (step 39b) or the system automatically determined the business category to be location sensitive (step 39a), the system establishes a suitable location specificity or “resolution” for the business category in step 41. A business category that is determined to be relatively more location sensitive may have a finer resolution than a category that is less location sensitive. For example, if a customer requests a coffee shop or a popular name recognized by the system as being included in the coffee shop category, the relevant resolution may be quite small, and the customer will most likely be interested in a coffee shop in a specific area. On the other hand, if a customer is interested in locating an automobile dealership, the location resolution may be quite large as there may be only one or two such dealerships within the area serviced by the system. In the illustrated embodiment, all business categories are associated with a resolution unless the customer specifically indicates that the location specificity is not important. However, a particular category may be determined by the system to be location non-specific such that it has a resolution that is generally equal to the entire area serviced by the system. It is to be understood that in another embodiment, when handling a call for a location non-specific category, the system could automatically handle the call by directly preparing a result as in step 40.

Based on the resolution determined in step 41, the system may generate a search result or the customer may be asked for more information to guide the search. For example, based on the category, the system may determine the customer's means of transportation to be important in a search result. Thus, the system, as shown in step 42, may enquire whether the customer has a preferred means of transportation and, if so, in step 43, determine that means of transportation by dialog with the customer or by generating a list of options. Based on the customer's preferred means of transportation, the relevant search area or resolution can be refined in step 44.

Alternately, where the system determines that the category of business is not transportation dependent, the system may deem the query based on means of transport to be unnecessary and move 42a to continue processing.

As shown in step 45, the system may generate queries to determine whether the customer desires a business that is in proximity to their current location, or proximal to another specified location. Again, depending on the business category of interest to the customer, such information may be unnecessary. However, it may be useful generate a location of interest enquiry, as in step 45, to ensure that the location of interest is within the area serviced by the system. The system can, for example, generate a query such as “Do you want to locate a business close to your present location?” The system will then await a “yes” or “no” response from the customer. The relevant location may then be established in step 46 or step 47, depending on the customer's response. Where a customer's current location is of interest, as in step 46, a dialog may not be necessary if LBS or reverse white pages information is available for the customer. If a customer's location cannot be automatically determined or if they desire a business in another location, a dialog can be established by the system to determine the location of interest to the user, as in step 47. Depending on the resolution that is necessary, depending on the business category of interest to the customer, the system may be interested only in determining a region of interest (i.e. downtown, north, south, neighborhood, etc.) within the service area or an actual street address or cross street location may be most useful.

From this point, the system may possess all the information required to find accessible businesses within the category, as in step 48. The system may use category attributes determined in step 41 and information collected from steps 42 to 47 to determine the accessible services within the category.

Businesses that are determined by the system to be accessible to the customer according to their location of interest are ranked by the system, as in step 49.

Since the relevancy of information presented to the customer will affect the customer's opinion of the system, the ranking of accessible businesses may be important. Ranking occurs in steps 40 and 49 and is handled in each step somewhat differently because of the relative importance of location to the business category. In step 40, the location was determined not be of importance and, therefore, the ranking may be based on points allotted to each business, for example as described hereinbefore. Points scoring, as previously described may be based on weighting factors such as, for example, any or all of the rate tier in the system to which the business has registered, ratings the business has received from previous customers, availability of promotions, etc.

In step 49, the location was determined as being important to the business category and in such a rating, and any accessible businesses may first be ranked by zoned proximity about, and/or direct proximity to, the customer's location of interest and then by points scoring. In this way, the businesses that are closest to, and thereby most convenient for, the customer may be returned with a higher ranking to the customer, which may enhance system usefulness, rather than basing the search result entirely on points scoring.

The ranked businesses may then be randomized to vary the order in which businesses with equal or similar rankings are presented to the customer. Of course, in one embodiment, if a registered business has the same ranking as a non-registered business, it may be advantageous to give the registered business a higher ranking than the non-registered business.

Thereafter, the results, which include a prioritized and randomized list of businesses within a selected business category, are presented to the user, as in step 50.

The following embodiment illustrates steps 48 and 49 in more detail based on data established in previous steps. While the previous steps can gather necessary information for the ranking of services, step 48 can carry out the actual prioritizing and randomizing algorithm. The prioritizing and randomizing algorithm, briefly described previously, can be configured so that the most relevant businesses (i.e., those that are in the correct category, closest to the customer's location, most accessible by the customer, etc.) can be presented first, regardless of whether the business is a member or a non-member. In one embodiment, relevance can be a function of proximity, service match, and value added information presented within the system (i.e., if there are two coffee shops where one is slightly closer than the second, but the second has a valuable coupon offering within multi-modal system 1, the second may be the most relevant even though it is not the closest and may be presented first).

The following embodiment illustrates the above discussion in symbolic notation. Let R, as determined from step 41, be a rectangular search region. A rectangle is used here for ease of description, but, as is apparent, R can be any shape that can be easily defined. Let Rx and Ry represent the minimum longitude and latitude of the search region and Rw and Rh be the width and height of the same region. Let L, as determined from steps 46 and 47, represent the location in which the service is desired. L will be considered as a point within R for this description, but, as is apparent, L can be any definable area within R. Let d(p,q), as determined from steps 42, 43, and 44, represent the distance between any two points p and q. The function d can be quite simple (i.e., a Euclidean distance) to very complex (i.e., a distance for walking, or a distance for driving, and the like). An estimate for driving distance can be the block distance where d(p,q)=|px qx|+|py qy|. Let D(p) be the normalized distance between p and L for p in R:
D(p)=d(p,L)/((Rw+Rh)/2)

D(p) will be in [0,1]. If L is not a point, or is not well defined, it can be approximated within [0,1]. For example, if L is a circle, the center of the circle can be used. If L is an arbitrary shape, the center of gravity of the shape can be used. The function D provides a normalized proximity for each possible service at point p.

Next, a weighting function W(d) is defined, which can map normalized distances to weights. W(d) is in [0,1]. The weighting function can be very general and can be W(d)=1−d or
W(d)={square root over ((1−(d*d)))}

To ensure that values remain within the range [0,1], a clipping function c(x) is also defined, where c(x)=x, if x is in [0,1], c(x)=0 if x<0, and c(x)=1 if x>1.

The business value of a service at location p is given by s(p) and is a function of logic processing unit 2. This “score” can be arbitrary and can be based on how much money a business spends, how popular it is, how many services it offers (such as coupons), and the like. S(p) is a function that maps arbitrary scores into a normalized score within [0,1]. An example of such a function is:
S(p)=1−e^{α(s(p)-(min(s)or max(s))}
where min(s) or max(s) is the minimum or the maximum score from region R, α=−(ln 20)/δ(s) and δ(s)=max(s)−min(s).

For equally ranked services, a random presentation order is applied, where R(x) is in the range (−x,x).

The final score for a given service p within R can be a combination of D(p) and S(p). One example of such a function is:
Score(p)=w(1 d)+S(p)(1−w), where
d=D(p)
w=c(W(d)+R(x))

As is apparent, different weighting functions, random factors and scoring functions can be used, if desired.

In one embodiment, the prioritizing and randomization algorithm can be spatially scalable. For example, the algorithm can be applied multiple times with increasing regions R. The results of each search can then be combined such that the first results always precede the second, or so that highly scored ranks from larger regions can interleave with earlier results. The steps by which R are increased can also be varied based on the density of the area around L. For example, within a dense inner city region, R may be defined as a circular radius centered on L that may be increased by 0.5 km, 1 km, 3 km, 6 km, 10 km, 20 km, 50 km. This may be desirable where a rapid mode of transport may be used by a customer. If the customer is walking, more refined results (i.e., 0.25 km, 0.5 km, 0.75 km, 1 km, 3 km, 5 km, etc.) may be desirable. If L is in a sparsely populated area, larger numbers may first be contemplated, for example 2 km, 5 km, 20 km, etc. In each of these examples, the results from smaller radiuses can precede all following ones, or a threshold can be applied such that some results can move. An example of such a threshold would be to multiply the scores coming out of the Score function by 1/radius. In this manner, services with high business scores that fall on the boundaries of regions can still be properly prioritized.

While the invention has been described in conjunction with the disclosed embodiment, it will be understood that the invention is not intended to be limited to these embodiments. On the contrary, the current protection is intended to cover alternatives, modifications and equivalents, which may be included within the spirit and scope of the invention. Various modifications will remain readily apparent to those skilled in the art.

1. A system for generating business information for a customer, the system comprising:
(a)a geo-indexed database including information on a plurality of businesses;
(b)a logic processing unit through which each business in the database is assigned to a business category and for associating criteria to each business category; and
(c)a customer interface to the logic processing unit for allowing a customer to enter a search request to locate a business within a selected business category, the logic processing unit determining the appropriate information to be gathered from the customer and generating a list of businesses based on the business category selected by the customer.

2. The system of claim 1, wherein the criteria associated with a business category includes a location specificity.

3. The system of claim 2, wherein the location specificity of a business category determines a location resolution in which businesses are added to the list of businesses generated by the logic processing unit.

4. The system of claim 1, wherein the logic processing unit determines a location of interest to the customer and generates a list of businesses ranked by their proximity to the location of interest, the location of interest determined to a resolution corresponding to the location resolution of the business category.

5. The system of claim 1, wherein the logic processing unit determines a location of interest to the customer and generates a list of businesses ranked by their proximity to the location of interest.

6. The system of claim 5, wherein the logic processing unit applies weighting factors to further rank the businesses in the list.

7. The system of claim 5, wherein the criteria associated with a business category includes a location specificity and the location specificity of a business category determines a location resolution relative to the location of interest in which businesses are added to the list of businesses generated by the logic processing unit.

8. The system of claim 1, wherein the search request is based on a business category of interest to the customer.

9. The system of claim 1, wherein the search request is based on a popular business name of interest to the customer and the logic processing unit associates the popular business name to a business category.

10. A multi-modal system to provide contact between a business and a customer comprising:
(a)a geo-indexed database including data about the business;
(b)a logic processing unit, providing access into said geo-indexed database;
(c)a business interface to the system, allowing a business to control the data; and
(d)a customer interface to the system allowing the customer to search the business data to locate a business of interest,
wherein, based on a customer search, the logic processing unit generates and prioritizes a search result including a list of businesses prioritized on the basis of business location sensitivity and business score from weighting factors.

11. The system of claim 10, wherein the logic processing unit randomizes the prioritized search results.

12. The system of claim 10, wherein the search results are prioritized using weighting factors selected from the group consisting of relevancy, accessibility or availability of promotions.

13. The system of claim 10, wherein the weighting factors include ratings from previous customers.

14. The system of claim 10, wherein the weighting factors include the businesses' status in a tiered rate structure system.

15. The system of claim 10, wherein the database groups businesses into categories including a pre-set location sensitivity.

16. The system of claim 10, wherein at least one of the business interface or the customer interface is based on voice and audio.

17. The system of claim 10, wherein the multi-modal system comprises an integration of prerecorded voice segments, audio clips, and TTS components.

18. The system of claim 10, wherein at least one of the customer interface and the business interface is a data, web or wap interface.

19. The system of claim 10, wherein the logic processing unit allows the customer to perform personalized or location sensitive searches.

20. The system of claim 10 further comprising an auditing and feedback function.

21. The system of claim 10 further comprising a function whereby electronic promotions are sent to the customer.

22. The system of claim 10, wherein the geo-indexed database includes material available to specific groups of customers.

23. The system of claim 10 further comprising a billing function.

24. The system of claim 23, wherein the billing function includes a tiered rate structure for the business.

25. The system of claim 23, wherein the billing function includes a per search request fee for the customer.

26. The system of claim 23, wherein the billing function includes a fee for the business for every instance of inclusion on a list of search results.

27. The system of claim 10, wherein the customer is connected to the business.

28. The system of claim 10, wherein the customer registers with the multi-modal system to provide feedback and to obtain promotions.

29. The system of claim 10, wherein location and communication device information is obtained from the customer's communication device or from the customer.

30. A method for generating business information for a customer, the method comprising:
(a)providing a geo-indexed database including information on a plurality of businesses and a logic processing unit through which each business in the database is assigned to a business category and for associating criteria to each business category;
(b)accepting a search request from the customer to determine a business category of interest to the customer; and
(c)operating the logic processing unit to obtain appropriate information from the customer based on the criteria associated with the business category of interest and searching the database to generate a list of businesses from the business category selected by the customer.

31. The method of claim 30, further comprising determining a location of interest to the customer and wherein the list of businesses is generated to highlight businesses proximal to the location of interest.

32. The method of claim 31, wherein the criteria associated with a business category includes a location specificity to determine the resolution to be used in assessing businesses proximal to the location of interest.

33. The method of claim 32, where in the location of interest to the customer need only be to the same resolution as the resolution determined by the location specificity.

34. The method of claim 31, wherein the list of businesses is ranked to list those businesses most proximal to the location of interest first.

35. The method of claim 34, wherein the list of businesses is further ranked by applying weighting factors to the businesses in the list.

36. The method of claim 30, wherein the search request is based on a business category of interest to the customer.

37. The method of claim 30, wherein the search request is based on a popular business name of interest to the customer and the logic processing unit associates the popular business name to a business category.

38. A method for providing business information to a customer from a business comprising:
(a)receiving a search request in a data, voice, or messaging format from a customer from a communication device, the search request specifying business information of interest and a location of interest;
(b)converting the search request to a digital signal representation understandable by a computer system;
(c)in response to the search request, assigning a location specificity to the business information of interest and searching a geo-indexed database of business information for a particular data item relating to the business information of interest;
(d)with reference to the location specificity of the business of interest, prioritizing search results based on proximity to the location of interest; and
(e)generating a list of prioritized search results into the format used for the search request.

39. The method of claim 38, wherein the prioritized search results are randomized.

40. The method of claim 38, wherein prioritizing the search results further includes scoring by applying weighting factors.

41. The method of claim 38, wherein the weighting factors include ratings from previous customers.

42. The method of claim 38, wherein the weighting factors include the businesses' status in a tiered rate structure system.

43. The method of claim 38, wherein the search is personalized by the customer.

44. The method of claim 38 further comprising a registration step whereby a customer registers and obtains a login name and password.

45. The method of claim 38, wherein a registered customer provides business ratings and requests promotional material.

46. The method of claim 38 further comprising a step of charging the customer a fee for each search request.

47. The method of claim 38 further comprising a step of charging businesses a fee for each instance of inclusion on a list of search results.

48. The method of claim 38 further comprising a step of obtaining location and communication device information from the customer or from the customer's communication device.

49. The method of claim 38 further comprising a step of directly connecting a customer with a business.

50. A method of presenting results obtained from an automated directory assistance system comprising prioritizing the results using weighting factors comprising relevancy and location, and randomizing the prioritized results.

51. The method of claim 50, wherein the weighting factors include ratings from previous customers.

52. The method of claim 50, wherein the weighting factors include the businesses' status in a tiered rate structure system.
